(19) United States
(12) Patent Application Publication
(10) Pub. No.: US 2014/0083090 A1
(43) Pub. Date: Mar. 27, 2014

(54) SEA-WAVE POWER GENERATION PLANT

(71) Applicants: Johan LARSSON, (US); Magnus PAULANDER, (US)

(72) Inventor: Johan LARSSON, Orebro (SE)

(73) Assignees: Magnus PAULANDER, Molnbo (SE); Johan LARSSON, Orebro (SE)

(21) Appl. No.: 13/626,561

(22) Filed: Sep. 25, 2012

(51) Int. Cl. F03B 13/22

(52) U.S. Cl. CPC F03B 13/22
USPC 60/398

(57) ABSTRACT

A sea-wave power generation plant including a turbine having an inlet opening and an outlet opening; a rig; and an axially extending pump unit. The stationary body is connected to the rig. The pump unit includes an axially extending stationary body, a diaphragm connected to the stationary body, and a pump chamber for a fluid. The pump chamber is at least partly defined by the diaphragm. The pump chamber is connected to the inlet opening of the turbine. The pump unit includes an axially extending movable body connected to the diaphragm. The movable body in the radial direction is arranged for reciprocating movement in relation to the stationary body to alternately compress and expand the pump chamber to pump the fluid to the turbine.

### TECHNICAL FIELD OF THE INVENTION

The present invention relates generally to the field of devices for sea-wave power generation. Further, the present invention relates specifically to the field of sea-wave power generation plants. The sea-wave power generation plant comprises a turbine having an inlet opening and an outlet opening; a rig; and an axially extending pump unit, wherein the stationary body is connected to said rig, wherein the pump unit comprises an axially extending stationary body, at least one diaphragm connected to said stationary body, and a pump chamber for a fluid, the pump chamber being at least partly defined by said at least one diaphragm, said pump chamber being connected to the inlet opening of the turbine.

### BACKGROUND OF THE INVENTION

Wind waves contain wave energy which basically is accumulated and stored wind energy. Further energy conversion to electrical energy can be made by the means of using a sea-wave power generation plant. In recent years, the interest to exploit renewable energy has increased. The use of certain types of energy, such as solar energy and wind energy, have increased rapidly while the exploitation of wave energy from water waves still remain relatively low in use. There is worldwide potential for the procurement of wave energy, which can be done with low environmental impact.

There are several challenges in the procurement of the wave energy as the energy source itself is inaccessible and displays a variable flow of energy. The energy flow of wind waves is a function dependent on wind speed and distance traveled for the accumulation of wind energy, where variations in wind speed and direction produce variation among the waves. Thus, the wave energy is an irregular source, where the irregularity affects the dimensions of the design. Wave energy is a clean and persisting source of energy, but it is a technically difficult challenge to produce a stable and efficient energy transformation and to do so in a cost efficient way.

There are various methods for energy transformation from wave energy. U.S. Pat. No. 4,145,882 disclose a sea-wave power generation plant comprising a pump chamber defined by a big flexible bag, and a turbine located in said bag. When the bag is exposed to forces originating from sea-waves a liquid housed in said bag is pumped through the turbine. However, the function of the sea-wave power generation plant of U.S. Pat. No. 4,145,882 is questionable, especially since the plant is solely arranged to be located at the bottom of the sea, independent on the depth of the actual location. The forces origination from sea-waves decreases in the vertical direction, and at great depths this power generation plant is of no use. The present invention is directed to a sea-wave power generation plant arranged to extract energy from the kinetic energy created by the water waves below or adjacent the surface.

### SUMMARY OF THE INVENTION

The present invention aims at obviating the aforementioned disadvantages and failings of previously known sea-wave power generation plants, and at providing an improved sea-wave power generation plant. A primary object of the present invention is to provide an improved sea-wave power generation plant of the initially defined type that is efficient and that extracts energy with a steady flow and high efficiency that at the same time has a low environmental impact.

The surface of the waves both rises above and falls below the level of the still water surface. Under the surface the water particles are set in motion. There are different theories about the exact movement, but can easily be described as the single water particle in its motion has a vertically plane circular orbit at greater water depths and a more elliptical orbit at shallow depths. During the time of a wave period, the wave has traveled the distance of a wavelength, i.e. the distance between two wave crests. In that same time, an arbitrary water particle has moved one lap in its orbit. By placing a device in the water below the surface, as a barrier to the movement of the water particles, energy is obtained from the force applied onto the surface of the device. The patent relates to a sea-wave power generation plant for extracting energy under the surface from the kinetic energy created by water waves. The sea-wave power generation plant uses the energy described above, and in particular the energy created by the vertical upward and downward motions in the water.

According to the invention at least the primary object is attained by means of the initially defined sea-wave power generation plant having the features defined in the independent claims. Preferred embodiments of the present invention are further defined in the dependent claims.

According to the present invention, there is provided a sea-wave power generation plant of the initially defined type, which is characterized in that the pump unit comprises an axially extending movable body connected to said at least one diaphragm, the movable body in the radial direction being arranged for reciprocating movement in relation to said stationary body in order to alternately compress and expand the pump chamber in order to pump said fluid to the turbine.

The device is arranged under the surface and encloses fluid and can be completely, or partially, covered by a flexible diaphragm. The diaphragm of the device is affected by forces created by the, below surface, kinetic energy created by the water waves. The force to the diaphragm applies pressure onto it and causes it to move, which also sets the device and the fluid enclosed by the diaphragm, in motion. At the opposite side of the diaphragm, within the device, an stationary body is placed, and when the diaphragm is subjected to pressure, the pressure moves the diaphragm towards the side of the stationary body whereby a constriction occurs between the diaphragm and the stationary body where the motion in the diaphragm and the constriction momentarily moves in the axial/longitudinal direction along the diaphragm, in synchronism with the movement of the waves on the surface at the sea. Thus, the diaphragm presses the fluid in the direction of the motion of the wave. The unit includes a device for extracting energy from the kinetic energy created below the surface and by the motion of the waves.

The energy is then extracted by transferring the fluid through a turbine. The sea-wave power generation plant comprises a closed loop that circulates the fluid within the sea-wave power generation plant, or an open circuit with an inlet and outlet for fluid into and out of the sea-wave power generation plant. The fluid is transferred through the sea-wave power generation plant by pumping fluid at the movement of the constriction synchrony with the movement of the waves on the surface at the sea.

In the device for pumping and propulsion of fluid within a closed circuit/loop, the level of filling within the device is adapted so that one or more constrictions between the diaphragm and the stationary body may be contained within the device simultaneously. The device for pumping and propulsion the fluid in an open circuit operates with the phases of intake, constriction between the diaphragm and stationary body, pumping and propulsion of the fluid, in which one or more constrictions between the diaphragm and the stationary body may be contained within the device simultaneously. The device with an open circuit is containing fluid, the volume of which is adjusted to the size in the phase of intake. The number of constrictions within the device of a closed or open circuit is dependent on the length of the device and the current wavelength of the surface; thus, the device uses part of a wavelength, full wavelength or multiple wavelengths simultaneously within the intended area of energy absorption for the device. With several simultaneous wavelengths flowing over the device for pumping and for propulsion of fluid, a more uniform fluid flow is obtained through the turbine for extracting energy from waves of the water.

Pressure on the enclosed fluid within the device for pumping and propulsion the fluid is amplified by a movable body, e.g. a wing, which by the forces of the movements in the surrounding water transfer these onto the diaphragm.

A device for pumping and propulsion of fluid uses, in a single-action design, the vertical upward and downward motions in the water which then provides a pumping and propulsive power per wavelength. According to one embodiment, the device for pumping and propulsion of fluid is of double-action design, i.e. utilizes both the vertical upward and downward motions in the water, which then generates two pumping and propulsive effects per wavelength.

The sea-wave power generation plant may be an anchored under water device or a fixed bottom-anchored device.

The sea-wave power generation plant can be connected to a buoyancy device.

The invention of the sea-wave power generation plant has one or more of the following characteristics:
1) The device is situated under the water surface,
2) The device has a turbine to extract energy from water waves,
3) Fluid is used in the device for powering the turbine,
4) A device for pumping and propulsion of the fluid within the sea-wave power generation plant uses the movements in the water, created by water waves, to set the fluid within the device in motion,
5) The device for pumping and propulsion of fluid within the device can use several wavelengths simultaneously within the, for the device intended, area of the energy absorption, which provides a more even fluid flow through the turbine for extracting energy from the water waves,
6) The device uses a relatively large area of the wave length for energy conversion,
7) Pressure on the devices enclosed fluid is amplified by a movable body with transfer forces onto the diaphragm from the surrounding water,
8) Devices for pumping and propulsion of fluid is performed in single-acting or double acting design that provides one respective two pumping and propulsion effects per wave period,
9) The device is arranged as an anchored under water device or a fixed bottom-anchored device,
10) The device can be connected to a buoyancy device.

Further advantages with and features of the invention will be apparent from the other dependent claims as well as from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is an example of a sea-wave power generation plant with a closed circuit,

FIG. 2 is an example of a sea-wave power generation plant with an open circuit,

FIG. 3a-3e schematically illustrates and explains the operation of the device for the pumping and propulsion of the fluid,

FIGS. 4a-4q are examples of alternative embodiments of the device for the pumping and propulsion of the fluid,

FIGS. 5a-5d illustrates different embodiments of the stationary body device for the pumping and propulsion of the fluid,

FIG. 6 is a more detailed example of a sea-wave power generation plant with a closed circuit according to FIG. 1,

FIG. 7 illustrates a sectional view, transversely to the pumped fluid in its direction of motion energy, of the sea-wave power generation plant shown in FIG. 1.

FIG. 8 is a more detailed example of a sea-wave power generation plant with an open circuit according to FIG. 2,

FIG. 9 is a sectional view, transversely to the pumped fluid in its direction of motion, illustrated in the sea-wave power generation plant in FIG. 2,

FIG. 10 illustrates a top view and the movable body illustrated in the sea-wave power generation plant in FIG. 2.

### DETAILED DESCRIPTION OF PREFERRED EMBODIMENTS OF THE INVENTION

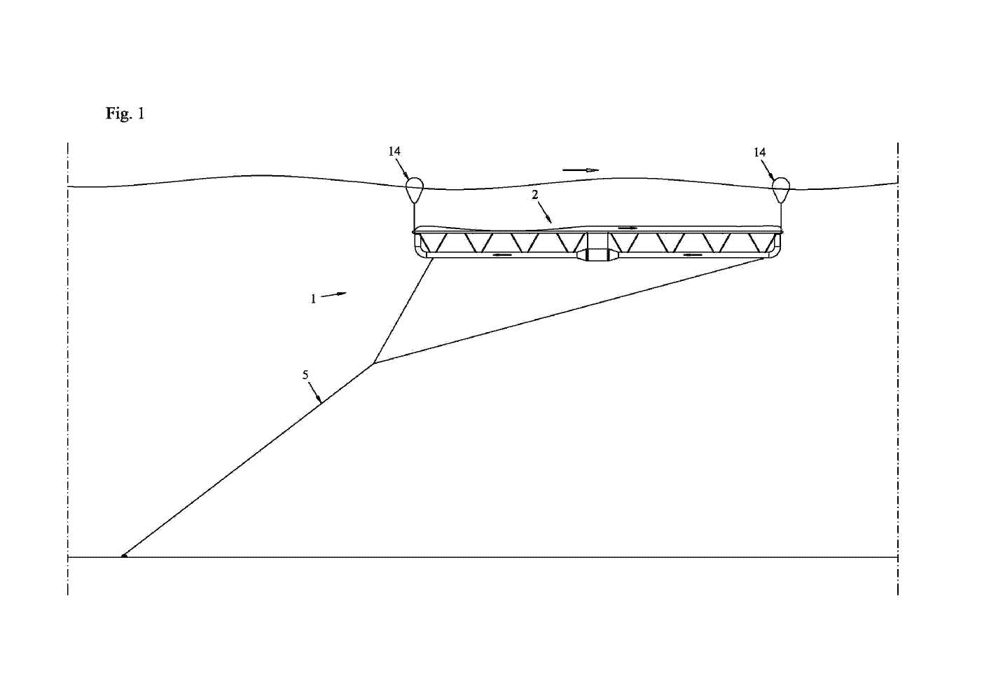

FIG. 1 illustrates a side view of a sea-wave power generation plant 1, for the extraction of energy from the kinetic energy created below the surface by water waves, where the sea-wave power generation plant 1 has a closed circuit for the pumping and circulating of the fluid 8 (gas or liquid) within the sea-wave power generation plant 1. Device 2 acts like a pump and transfers the contained fluid 8 within the sea-wave power generation plant 1.

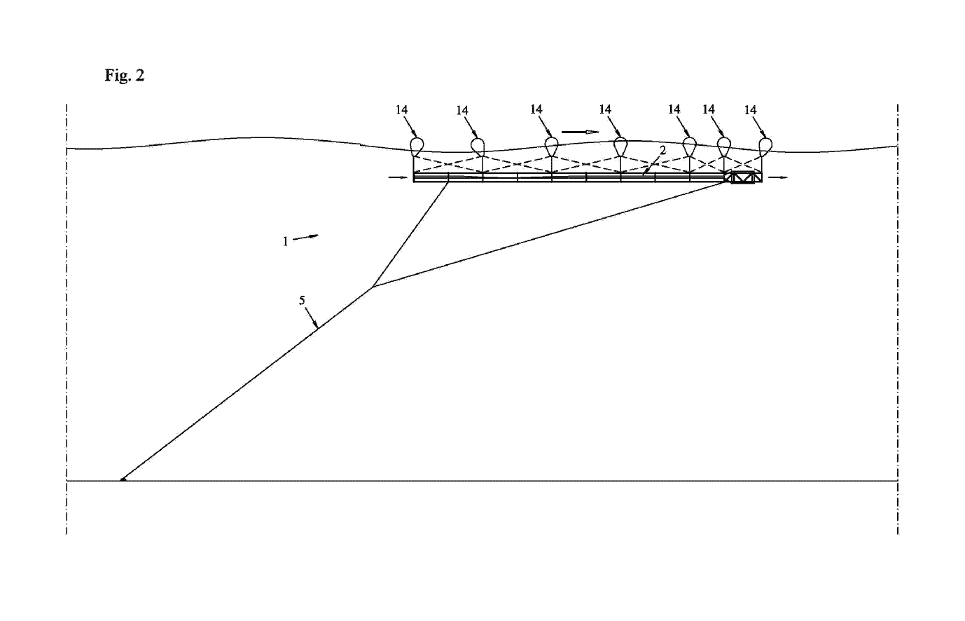

FIG. 2 illustrates a side view of a sea-wave power generation plant 1, for the extraction of energy from the kinetic energy created below the surface by water waves, where the sea-wave power generation plant 1 has an open circuit for the pumping of the fluid 8 within the sea-wave power generation plant 1. Device 2 acts like a pump and transfers the contained fluid 8 within the sea-wave power generation plant 1.

FIG. 1 and FIG. 2 illustrates the sea-wave power generation plant 1, as a device anchored under water. Alternatively, the sea-wave power generation plant 1 may be carried out as a fixed bottom-anchored device, not illustrated. One or more of anchoring device 5 is applied, as appropriate, for the sea-wave power generation plant 1. The sea-wave power generation plant 1 can be performed with one or more attachment points to the anchoring device. Anchoring of the sea-wave power generation plant 1 is performed on one or more attachment points to the bottom or one or more attachment points above the water, or a combination of both. FIG. 1 and FIG. 2 shows an example of embodiment of anchoring device 5 with two supports to the sea-wave power generation plant 1 and with a fastening point at the bottom of the sea which enables to secure the sea-wave power generation plant 1, FIG. 1 and FIG. 2, to turn in the direction of the waves.

If sea-wave power generation plant 1, according to FIG. 1 and FIG. 2, could not be maintained in the desired vertical position because of inadequate buoyancy of the anchoring device 5 a floating device 14 is applied to the assembly 1. The performance of the buoyancy device 14 varies depending on the sea-wave power generation plants 1 weight, balance, stability and desired vertical position and inclination.

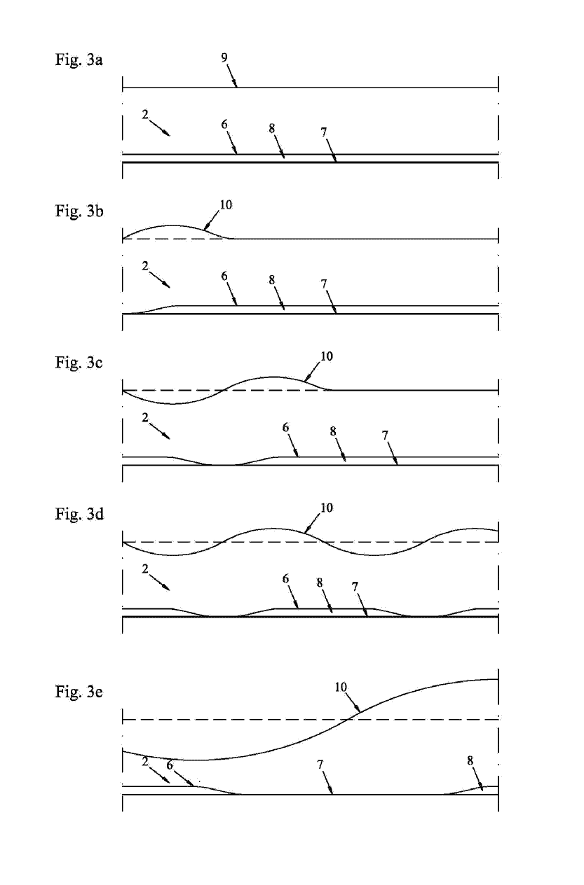

FIGS. 3a-3e explain a schematic sectional view, in the direction of the water wave motion, of device 2 in FIG. 1 and FIG. 2, which acts like a pump.

FIG. 3a illustrates device 2 with a flexible diaphragm 6 the stationary body 7 and the contained fluid 8 in an unaffected embodiment in calm water 9.

FIG. 3b illustrates a water wave 10, with the direction of movement from left to right, approaching device 2 and the diaphragm 6 which is affected by the forces created by the water waves 10 and the kinetic energy created below the surface of the water. The force against the diaphragm 6 applies pressure to the diaphragm 6 and sets it in motion, which momentarily within the device 2 and by the diaphragm 6 enclosed fluid 8 also is set in motion. At the opposite side of the diaphragm 6 a stationary body 7 is placed and when the diaphragm 6 is subjected to pressure, it moves the diaphragm 6 towards the side of the stationary body 7 whereby a constriction occurs between the diaphragm 6 and the stationary body 7.

In FIG. 3c, the pressure to the diaphragm 6 and the constriction that occurs, has moved longitudinally along the diaphragm 6 in synchronism with the movement of the water wave 10. The diaphragm 6 presses the fluid 8 in the direction of the wave motion.

In FIG. 3d several constrictions occur along the total length of the device 2 when the pumping and propulsion of fluid 8 occurs. The number of constrictions contained in the device 2 is dependent on the length of the device 2 and the current wavelength 10.

In FIG. 3 only one constriction occurs within the entire length of the device 2 illustrated as only a portion of the length of the device, so that when the constriction in the device 2 is passing the whole length of the device 2 its pumping of fluid 8 is going to stop until the next water wave 10 applies pressure, whereby a new constriction between stationary body and diaphragm 6 and 7 occurs. The fact that only a part of the length of a water wave is fitted within the device 2 occurs when the designed length of the device 2 is less than the water wave 10 wavelengths. High winds create long wavelengths and the length of the device 2 is adapted to the most cost efficient length in relation to the duration of the wavelengths and the heights of the waves 10 during a year at each intended location of the devices, in the purpose of providing prime stability and prime functioning 2. The continuous use of at least one whole wavelength or multiple wavelengths simultaneously within the device 2, and for the intended area of power procurement, will provide a more uniform flow of fluid 8.

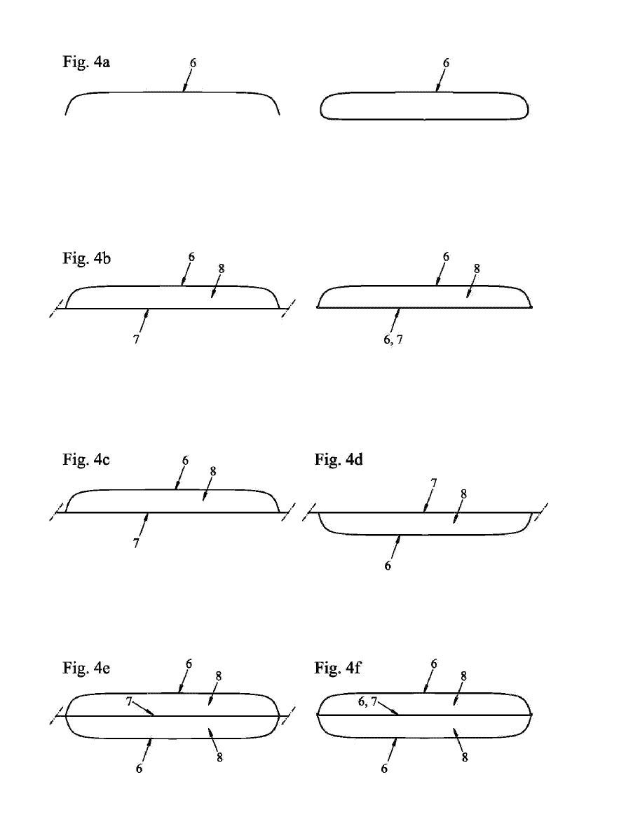

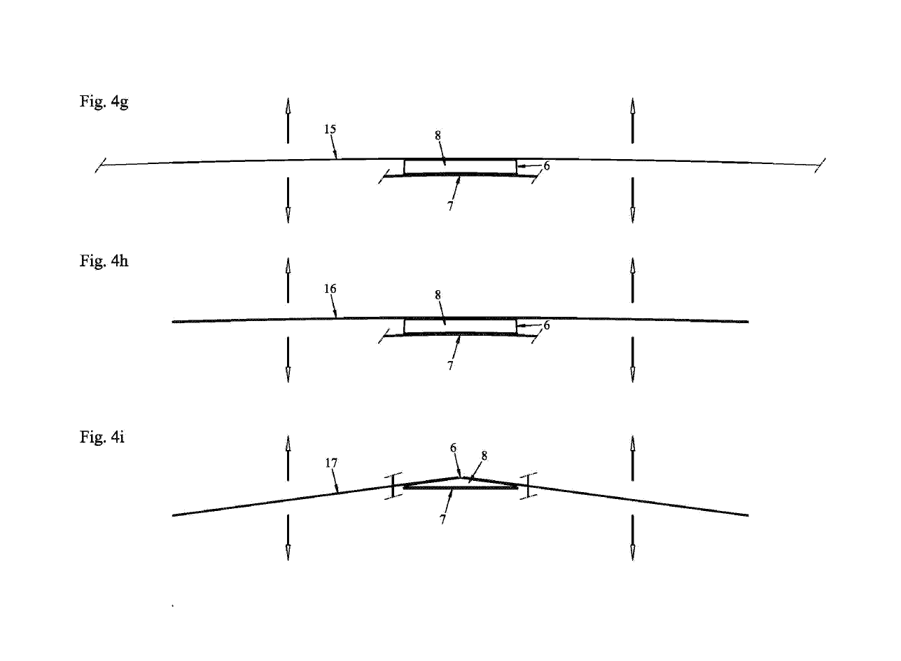

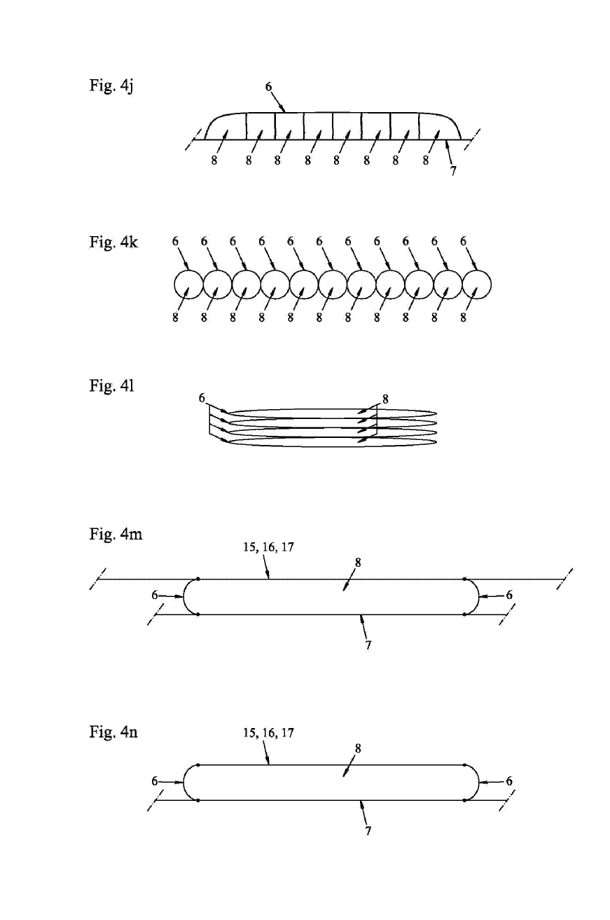

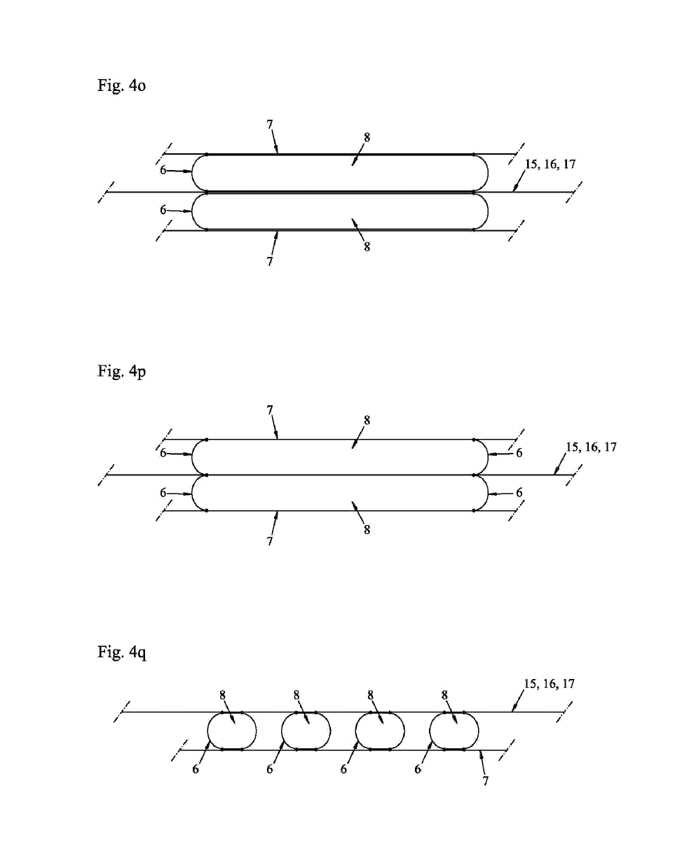

FIG. 4a-4q represents a schematic sectional view, transversely to the pumped fluid 8 in its direction of motion energy, of the diaphragm 6 and stationary body 7 corresponding to that of FIG. 1 and FIG. 2 where the device 2, which acts like a pump, can be completely or partially covered by a diaphragm. Pumping and propulsion of fluid 8 within the sea-wave power generation plant 1 can be achieved with the device 2 in a variety of ways in which the alternative embodiments are presented below.

FIG. 4a illustrates a flexible diaphragm 6 in two basic designs where the left one, in its execution, has an open periphery and in the right version, it has a seal around its periphery. A sealed diaphragm 6 can also be shaped like a hose.

FIG. 4b illustrates a flexible diaphragm 6 where the edges of the left-hand embodiment of the diaphragm, as appropriate, is secured to an stationary body 7 and together they form an enclosure for fluid 8.

In the right-hand embodiment, the diaphragm 6 is enclosed in its periphery and by, as appropriate, applying the attachment points on the diaphragm 6 the diaphragm 6 will form an own stationary body on which the attachment points are stretched and therefore extend the diaphragm 6.

FIG. 4c illustrates a single-acting design with stationary body 7 and the diaphragm 6 oriented upwards, towards the surface.

FIG. 4d illustrates a single-acting design with stationary body 7 and the diaphragm 6 oriented downwards from the surface.

FIG. 4e illustrates a double-acting design with the stationary body 7 and the diaphragm 6 on each side of the stationary body 7.

FIG. 4f illustrates a double-acting design with diaphragms 6 with at least one circumferentially enclosed diaphragm 6 and where the stretched diaphragm 6 is used as a stationary body 7.

Device 2, for pumping and propulsion of fluid 8, uses a single-action design either capturing the upward or downward movements of the water, which then provide a pumping and propulsive power per wavelength. Device 2, for pumping and propulsion of fluid 8, when utilizing a double-action design, captures both the upward and the downward movements of the water, which then provide two pumping and propulsive effects per wavelength.

FIG. 4g illustrates an embodiment with an attached movable body 15 whose side tips are, appropriately, attached to the sea-wave power generation plant 1. The movable body 15 may come in the form of a flexible sheet of materials and are secured, as appropriate, to the diaphragm 6.

FIG. 4h illustrates an embodiment with an attached movable body 16 whose side tips are not secured. The movable body 16 may come in the form of a rigid sheet of materials and are secured, as appropriate, to the diaphragm 6.

FIG. 4i illustrates an embodiment of a movable body 17 which is hinged at the center, or divided in a two-part, whose outer side tips are not secured, but have a support or an attachment, which inverts the movement of the inner lateral tips. The wing 17 is fastened, as appropriate, to the diaphragm 6.

FIG. 4g-4i illustrates embodiments where the pressure of the contained fluid 8 is amplified by a movable body 15, 16-17 which by absorbing the energy from the movements in the surrounding waters and through transmission of the power to the diaphragm 6 for applying pressure against the device 2 and its enclosed fluid 8.

FIG. 4j illustrates an embodiment where the diaphragm 6 is assembled with dividers for the separation of the contained fluid 8. The divider is flexible and it limits the vertical mobility of the diaphragm 6 and can also be used, if necessary, when there is a need to allocate the flow within the device 2.

FIG. 4k-4l illustrates a version of device 2 with several, by the diaphragm 6 separated, enclosed devices of fluid 8. In device 2, several separate enclosures can be performed within the width or the height, or in a combination of both.

FIG. 4m illustrates a design with two diaphragms 6 around their open circumferences. The diaphragm is in its bottom part attached, as appropriate, to the stationary body 7 and in its upper part, as appropriate, attached to the movable body 15, 16-17 which together encloses the fluid 8.

FIG. 4n illustrates an embodiment similar to the design 4m described, but with a shortened movable body 15, 16-17 which causes pressure to build on the contained fluid 8.

FIG. 4o-4p illustrates two double-acting designs. FIG. 4o illustrates a combination of two stationary bodies 7 and a diaphragm in closed circumference 6 on each side of the stationary bodies 7. FIG. 4p illustrates a combination of two stationary bodies 7 and a diaphragm in its closed circumference 6 on each side of the stationary bodies 7. Throughout the diaphragm 6 a movable body 15, 16-17 is placed, as FIG. 4o-4p is illustrating.

FIG. 4q illustrates examples of how the above described embodiments, according to FIGS. 4a-4p, can be combined. Several separate diaphragms 6 provided with stationary bodies 7 and movable body 15, 16-17 to collect the forces from the surrounding movements in the waters, whereby the forces are transmitted to the device 2 and its contained fluid 8.

A diaphragm 6 with or without a stationary body 7 as shown in FIG. 4a-4q above can be combined with each other to form several embodiments. The invention is not limited to those embodiments described in FIGS. 4a-4q to device 2 for pumping of fluid 8. More combinations are possible, but not described or illustrated.

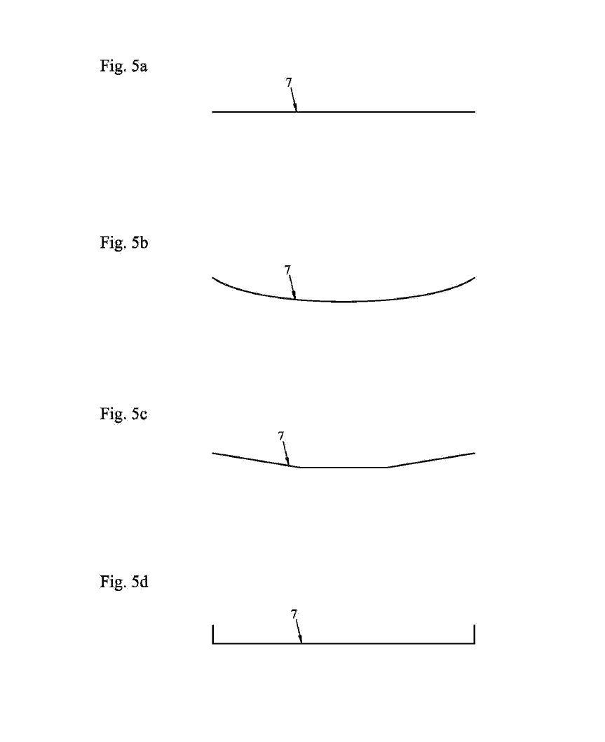

FIGS. 5a-5d illustrate examples of embodiments that are not limited for the invention of the stationary body 7 in which FIG. 5a is flat, FIG. 5b is arched and where FIG. 5c-5d are composed of different angles or at different angles by weight. The stationary body 7 can also be assembled as a combination of several alternative embodiments.

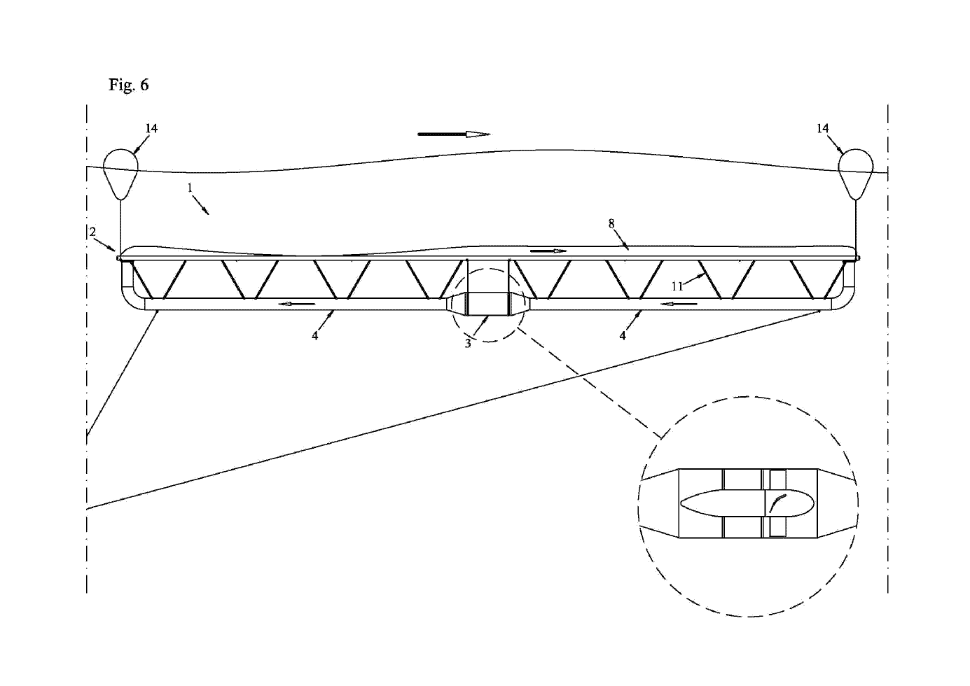

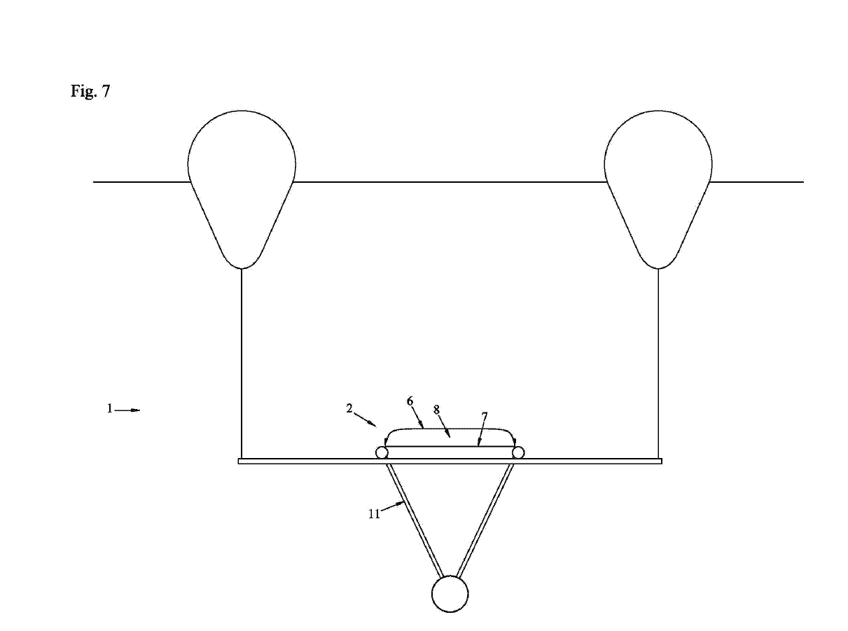

The device, 2 shown in FIG. 6, for the pumping and propulsion, is in a single-acting design and has an inlet and an outlet that, in an appropriate manner, with or without transition, is to be connected to a pipe or hose 4. The outlet from the device 2 is connected via pipes or hose 4 with or without transition, to the inlet of the turbine 3. The enclosed fluid 8 is being pumped from the outlet of the device 2 to the inlet of the turbine 3. The kinetic energy of the fluid 8 gets the turbine rotating by a shaft through a transmission of power from the turbine to an electric generator for conversion into electrical energy or to a compressor for the compressing of gas or to a pump for the pumping of fluid 8. The outlet from the turbine 3 connects, with or without a transition, through the tube or hose 4 to the device 2. After passing through the turbine 3 the fluid 8 is drawn from the outlet of the turbine 3 to the inlet of the device 2. Pipes or hose 4 may also be other suitable devices for the transport of the fluid 8 through the sea-wave power generation plant 1, not shown. The turbine 3 can also be placed directly by the outlet of the device 2 or directly at the inlet of the device 2, not shown, or placed somewhere arbitrarily in between. The sea-wave power generation plant 1 can be provided with one or more turbines 3, not shown. Alternatively, one or more devices 2 for the pumping of fluid 8 within the sea-wave power generation plant 1 can be connected to the turbine 3, not shown. The sea-wave power generation plant 1 can also be assembled as a subsequent device 2 with one or more turbines 3 alternately and/or subsequently, placed one after the other so that the backflow of the fluid 8 after the final stage is passing through the device in a suitable manner for the transit back to the first stage inlet of the turbine 3 of the device 2, not shown. The rig 11 is a construction and an arrangement for the sea-wave power generation plant 1 who has the task of holding together the sea-wave power generation plants 1 variety of parts and to stabilize the sea-wave power generation plant 1 with respect to external and internal forces. The rig 11 can be designed in several different ways; one way is that which is shown. The degree of filling of the sea-wave power generation plant 1 is adapted so that one or more constrictions are allowed to operate simultaneously within the devices 2 length. A device can be applied to the sea-wave power generation plant 1 for refilling or emptying of the sea-wave power generation plant 1.

FIG. 7 is a sectional view, transversely to the pumped fluid 8, in its direction of motion energy, as shown in FIG. 1 by sea-wave power generation plant 1. FIG. 7 illustrates the device 2 for the pumping and propulsion of the fluid 8 with the diaphragm 6 and the stationary body 7. The diaphragm 6 is illustrated at a given degree of filling with a particular embodiment of the device 2 and the stationary body 7 and at a given operating condition, in an arbitrary position between the constriction and the filling. Rig 11 is shown in an alternative embodiment, with the task of holding together the variety of parts of the device and to stabilize the sea-wave power generation plant 1 with respect to external and internal forces.

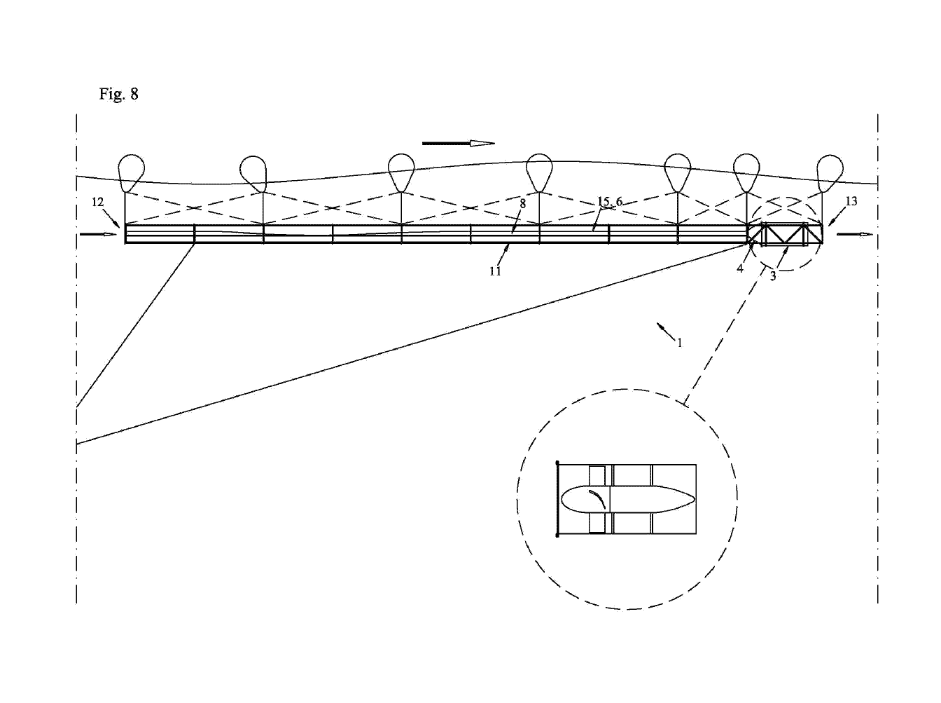

The device 2, as illustrated in FIG. 8, for the pumping and propulsion, is in a single-acting design and has an inlet 12 and an outlet 13. The outlet 13 connects to a pipe or hose 4, with or without transition to the inlet of the turbine 3. The enclosed fluid 8 is pumped from the outlet 8 of the device 2 to the inlet of the turbine 3. The kinetic energy from the fluid 8 causes the turbine to rotate and is transmitted via a shaft from the turbine to an electric generator for conversion to electrical energy or to a compressor for the compressing of gas or to a pump for pumping fluid 8. Alternative the outlet of the turbine 3 may be connected to a pipe or hose 4, with or without transition, to the inlet 12, not shown. Pipe or hose 4 may also be other suitable devices for the transport of fluid 8 through the sea-wave power generation plant 1, not shown. The turbine 3 can be placed directly on top of the outlet or inlet, not shown, on the device 2. The sea-wave power generation plant 1 can be provided with one or more turbines 3, not shown. Alternatively, one or more devices 2 for the pumping and propulsion of the fluid 8 in the sea-wave power generation plant 1 can be connected to a turbine 3, not shown. The sea-wave power generation plant 1 can also be assembled as a subsequent device 2 and one or more turbines 3 alternately and/or subsequently, be placed one after the other, not shown. The movable body 15 collects the forces from the surrounding movements in the waters, whereby the forces are transmitted to the device 2 and its contained fluid 8. The rig 11 is a construction and arrangement for the sea-wave power generation plant 1 who has the task of holding together the devices variety of parts and to stabilize the sea-wave power generation plant 1 with respect to external and internal forces. The rig 11 can be designed in several different ways; one way is that which is shown. The, within the device 2, open circuit containing fluid 8 volume is adjusted to the size of the phase of the suction of ambient water after the phase of the constriction of the diaphragm 6. By using the opposing forces following constriction it provides a lifting force to the diaphragm 6 which in turn achieves a suction effect. Towards the inlet 12 a check valve or gate valve can be connected, not illustrated, to counteract an initially misaligned flow within the device 2 leading back towards the inlet 12 caused when pressurized prior to the constriction is reached and the pumping takes place. In a double acting embodiment of the device 2 a check valve or gate valve is connected to the outlet 13 to prevent back flow and the filling of the side not being pressurized.

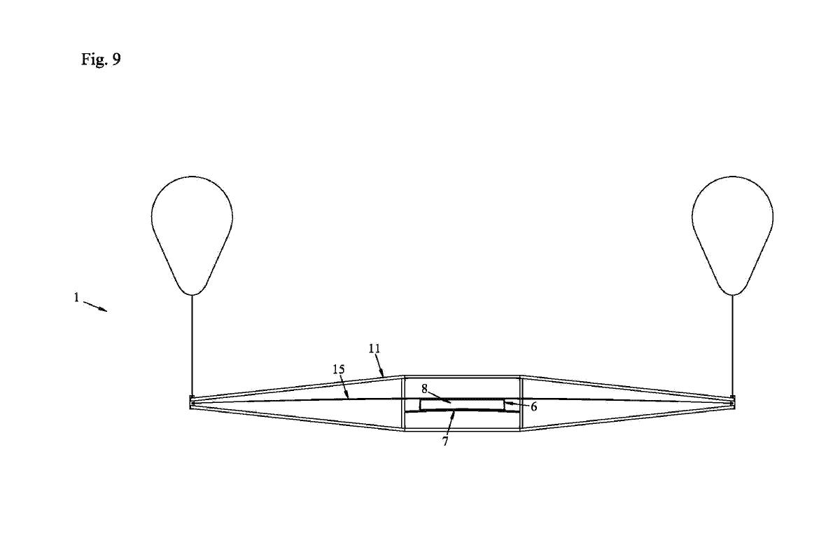

FIG. 9 is a sectional view, transversely in the direction of the motion energy of the pumped fluid 8, as illustrated by FIG. 2 through the sea-wave power generation plant 1. FIG. 9 illustrates the device 2 for pumping the fluid 8 with the diaphragm 6 and the stationary body 7. The diaphragm 6 illustrates, at a given degree of filling with a particular embodiment of the device 2, and the stationary body 7 is illustrated at a given operating condition, with an arbitrary position between the constriction and the filling. The movable body 15 collects the forces from the surrounding movements in the waters, whereby the forces are transmitted to the device 2 and its contained fluid 8. The rig 11 is shown in an alternate embodiment, and has the task of holding together the devices variety of parts and to stabilize the sea-wave power generation plant 1 with respect to external and internal forces.

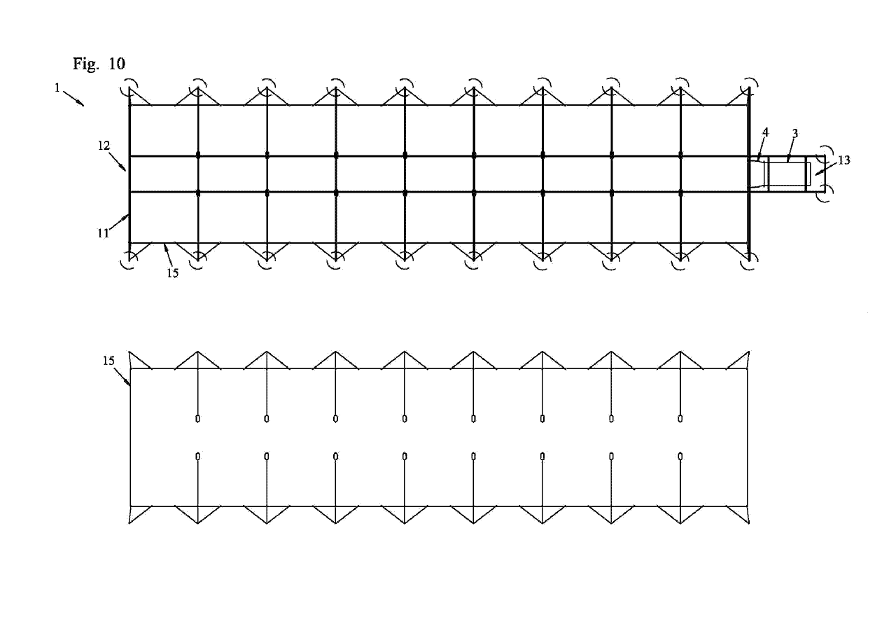

FIG. 10 illustrates an top view of the sea-wave power generation plant 1, according to FIG. 2 and FIG. 8, and the movable body 15 is illustrated in selected alternative embodiment where the shown device 2 is for the pumping and propulsion of the fluid 8.

### FEASIBLE MODIFICATIONS OF THE INVENTION

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims. It shall be pointed out that all information about/concerning terms such as above, under, upper, lower, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design. It shall also be pointed out that even thus it is not explicitly stated that features from a specific embodiment may be combined with features from another embodiment, the combination shall be considered obvious, if the combination is possible.

1. A sea-wave power generation plant (1) comprising a turbine (3) having an inlet opening and an outlet opening; a rig (11); and an axially extending pump unit (2), wherein the stationary body (7) is connected to said rig (11), wherein the pump unit (2) comprises an axially extending stationary body (7), at least one diaphragm (6) connected to said stationary body (7), and a pump chamber for a fluid (8), the pump chamber being at least partly defined by said at least one diaphragm (6), said pump chamber being connected to the inlet opening of the turbine (3), wherein the pump unit (2) comprises an axially extending movable body (15, 16, 17) connected to said at least one diaphragm (6), the movable body (15, 16, 17) in the radial direction being arranged for reciprocating movement in relation to said stationary body (7) in order to alternately compress and expand the pump chamber in order to pump said fluid (8) to the turbine (3).

2. The sea-wave power generation plant (1) according to claim 1, wherein the at least one diaphragm (6) and the stationary body (7) defines said pump chamber.

3. The sea-wave power generation plant (1) according to claim 1, wherein the at least one diaphragm (6) defines said pump chamber.

4. The sea-wave power generation plant (1) according to claim 1, wherein the at least one diaphragm (6), the stationary body (7) and the movable body (15, 16, 17) defines said pump chamber.

5. The sea-wave power generation plant (1) according to claim 1, wherein the pump unit (2) comprises a plurality of pump chambers.

6. The sea-wave power generation plant (1) according to claim 1, wherein the pump unit (2) comprises two stationary bodies (7) connected to said rig (11), the movable body (15, 16, 17) being located between said two stationary bodies (7), wherein at least one diaphragm (6) is connected to each of the two stationary bodies (7) and to the movable body (15, 16, 17).

7. The sea-wave power generation plant (1) according to claim 1, wherein the movable body (15) is made of flexible sheet of material connected to the rig (11).

8. The sea-wave power generation plant (1) according to claim 1, wherein the movable body (16, 17) is made of a rigid sheet of material.

9. The sea-wave power generation plant (1) according to claim 8, wherein the movable body (16, 17) is made of a rigid sheet of material connected to the rig (11).

10. The sea-wave power generation plant (1) according to claim 1, wherein the pump chamber is connected to the outlet opening of the turbine (3).

11. The sea-wave power generation plant (1) according to claim 1, comprising a buoyage (14) connected to said rig (11).
